(19) United States
(12) Patent Application Publication
(10) Pub. No.: US 2013/0240136 A1
(43) Pub. Date: Sep. 19, 2013

(54) METHOD OF MANUFACTURING DRIP ABSORBENT SHEET

(71) Applicants: Yoshinori Tanaka, Kagawa (JP); Naohito Takeuchi, Kagawa (JP)

(72) Inventors: Yoshinori Tanaka, Kagawa (JP); Naohito Takeuchi, Kagawa (JP)

(73) Assignee: Uni-Charm Corporation, Shikokuchuo-shi (JP)

(21) Appl. No.: 13/876,505

(22) PCT Filed: Sep. 27, 2011
(86) PCT No.: PCT/JP2011/005429

§ 371 Date: Jun. 7, 2013

(30) Foreign Application Priority Data
Sep. 30, 2010 (JP) 2010223034

(51) Int. Cl. B32B 37/16

(52) U.S. Cl. CPC B32B 37/16
USPC 156/256; 156/250

(57) ABSTRACT

In a method of manufacturing a drip absorbent sheet, the drip absorbent sheet having: a plurality of holes through which drip, which is juice released from foodstuff, can pass; a porous resin film containing 1 to 3% by mass of a surface-active agent, and a liquid absorbent layer laminated with the porous resin film. The method includes at least: a laminating step of laminating the porous resin film and the liquid absorbent layer; a cutting step of cutting a laminate obtained in the laminating step into a product of a predetermined product dimension; and a product stacking step of stacking the product in sheets after the cutting step into stacks of a plurality of sheets. In at least one of the cutting step and the product stacking step, a contactless charge neutralization process is performed with respect to a front surface side of the porous resin film.

### TECHNICAL FIELD

The present disclosure relates to a method of manufacturing a drip absorbent sheet.

### BACKGROUND ART

In a food department of a supermarket and the like, a foodstuff such as fish and meat is on sale in a state of being divided into a predetermined portion in a tray wrapped in a transparent film. In such a marketing form, the foodstuff stays in a display shelf for a prolonged time and drip tends to accumulate in the tray. Since the drip accumulated in the tray not only impairs the appearance but also accelerates spoiling of the foodstuff, a drip absorbent sheet for absorbing drip is generally laid on the tray on which a foodstuff that releases drip, such as meat and fish, is placed.

A drip absorbent sheet with a porous resin film disposed on a surface of a liquid absorbent layer has been known to the inventor(s). In such a drip absorbent sheet with an opaque porous plastic sheet with a large number of three-dimensional pores disposed on the surface of the liquid absorbent layer having liquid absorbing properties, the porous sheet having the large number of pores separates the absorbed drip in the liquid absorbent layer from the foodstuff and does not leave drip on the surface of the drip absorbent sheet. This improves the appearance of the foodstuff placed on the tray and prevents spoiling of the foodstuff from progressing due to the drip.

In order to reduce drip remaining on a surface of the porous resin film, a porous resin film with pores of a greater dimension can be used. However, the greater the dimension of the pores, the greater the likelihood of backflow of drip absorbed by the liquid absorbent layer back to the surface of the resin film. In addition, the color of the drip absorbed by the liquid absorbent layer is more readily visible through pores of a greater dimension.

In order to reduce the drip remaining on the surface of the porous resin film without increasing the dimension of the pores, water repellency of the surface of the porous resin film can be increased. By increasing water repellency of the surface of the film, the drip contacting the surface of the film runs on the surface more easily and is absorbed by the liquid absorbent layer through the pores more easily.

However, by increasing water repellency of the surface of the porous resin film, the surface of the porous resin film is more easily electrically charged. As a result, for example, during the manufacturing process of a drip absorbent sheet under adverse conditions such as dry atmosphere in winter, static electricity is frequently generated on the surface of the porous resin film. This may cause troubles such as multi-sheet feed due to failed suction and/or electrostatic attraction, resulting in a barrier to stable and high-speed manufacturing of drip absorbent sheets.

To address such a problem, it has been known to the inventor(s) to moderately prevent generation of static electricity by applying, for example, a surface active agent on a fiber layer of the liquid absorbent layer, thereby adjusting electrically-charged load on a surface of the liquid permeable layer.

### SUMMARY OF INVENTION

According to an aspect of the present invention, a method of manufacturing a drip absorbent sheet is provided. The drip absorbent sheet includes a porous resin film containing 1 to 3% by mass of a surface-active agent and having a plurality of holes through which drip from a foodstuff is passable, and a liquid absorbent layer laminated with the porous resin film. The method includes: a laminating step of laminating the porous resin film and the liquid absorbent layer; a cutting step of cutting a laminate obtained in the laminating step into a plurality of drip absorbent sheets of a predetermined product dimension; and a product stacking step of stacking the drip absorbent sheets after the cutting step into stacks. In at least one of the cutting step and the product stacking step, a contactless charge neutralization process is performed with respect to a front surface side of the porous resin film.

According to another aspect of the present invention, a method of manufacturing a drip absorbent sheet is provided. The drip absorbent sheet includes a porous resin film containing 1 to 3% by mass of a surface-active agent and having a plurality of holes through which drip from a foodstuff is passable; and a liquid absorbent layer laminated with the porous resin film. The method includes: a cutting step of cutting a laminate of the porous resin film and the liquid absorbent layer into a plurality of drip absorbent sheets of a predetermined product dimension; and a product stacking step of stacking the drip absorbent sheets after the cutting step into stacks. In at least one of the cutting step and the product stacking step, a contactless charge neutralization process is performed with respect to a front surface of the porous resin film.

### BRIEF DESCRIPTION OF DRAWINGS

FIG. 1 is a top view of a drip absorbent sheet according to an embodiment;

FIG. 2 is a side view of the drip absorbent sheet according to the present embodiment; and

FIG. 3 is a diagram schematically showing processes in a method of manufacturing the drip absorbent sheet according to the present embodiment.

### DESCRIPTION OF EMBODIMENTS

In accordance with some embodiments, a surface active agent is included in a porous resin film of a drip absorbent sheet in a particular proportion of a limited range. A contactless charge neutralization process is performed with respect to a front surface of the porous resin film in a manufacturing process of the drip absorbent sheet. As a result, a method that allows low-cost, high-speed, and stable manufacture of drip absorbent sheets with less drip is provided.

One or more embodiments of the present invention will be described in detail hereinafter; however, it should be noted that the present invention is not limited thereto, and can be changed and implemented as necessary without escaping the scope of this disclosure.

Basic Configuration of Drip Absorbent Sheet

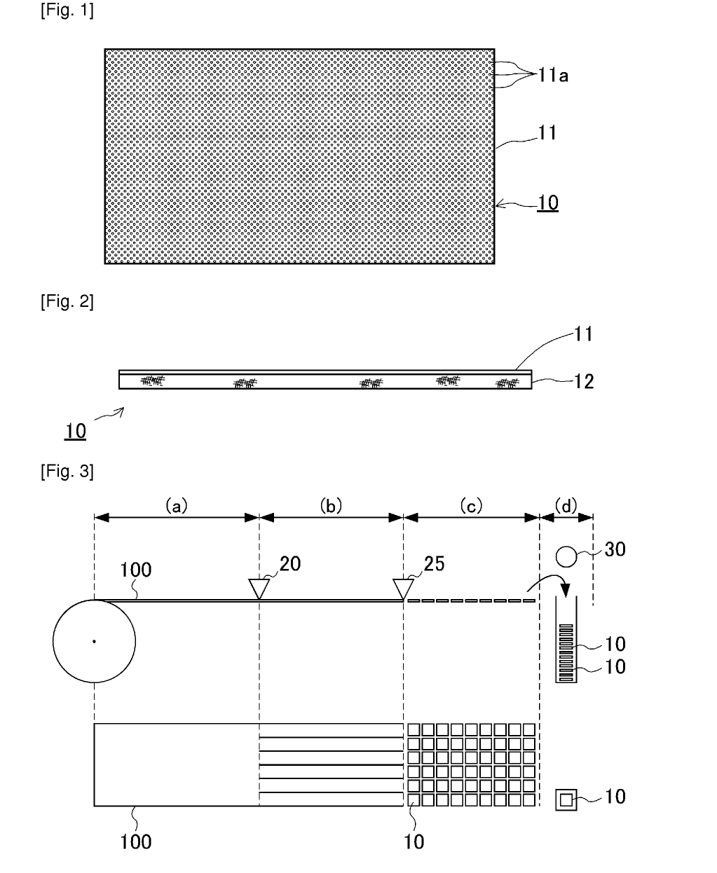

A basic configuration of a drip absorbent sheet according to an embodiment of the present invention is described hereinafter with reference to the drawings. First, FIGS. 1 and 2 are diagrams showing a configuration of the drip absorbent sheet according to the present embodiment, FIG. 1 showing a top view and FIG. 2 showing a side view.

As shown in FIGS. 1 and 2, a drip absorbent sheet 10 according to the present embodiment is configured such that a porous resin film 11 with a large number of pores 11a covers a surface of a liquid absorbent layer 12 that has liquid absorption properties.

In the drip absorbent sheet according to the present embodiment, the liquid absorbent layer 12 can absorb juice (drip) released from meat or fish, or any other foodstuff. On the other hand, the porous resin film 11 is composed of a cavernous resin film. With such a drip absorbent sheet 10 according to the present embodiment, meat juice (drip) released from a foodstuff placed on a front surface of the porous resin film 11 passes through the pores 11a of the porous resin film 11 and is absorbed by the absorbent layer 12. In such a case, since a contact area of the front surface of the porous resin film 11 with respect to the foodstuff is small, drip does not stay on the front surface and the foodstuff placed on the drip absorbent sheet 10 is completely separated from the drip, thereby preventing progression of spoilage of the foodstuff due to the drip.

Method of Manufacturing Drip Absorbent Sheet

In a method of manufacturing the drip absorbent sheet 10 according to the present embodiment, a laminating step for laminating the porous resin film 11 and the liquid absorbent layer 12 and a cutting step for cutting a laminate 100 obtained in the laminating step into a product of a predetermined product dimension are sequentially performed to manufacture a plurality of drip absorbent sheets 10. Thereafter, a product stacking step is performed for stacking the drip absorbent sheets 10 after the cutting step into stacks of the drip absorbent sheets 10, the stacks of the drip absorbent sheets 10 being finally shipped. In addition, in the method of manufacturing of the present embodiment, a contactless charge neutralization process is performed with respect to a front surface of the porous resin film 11 in at least one of the cutting step and the product stacking step. The laminating step, cutting step, and product stacking step are described hereinafter.

Laminating Step

First, the laminating step (not illustrated) is described. This step is for preparing the laminate 100 by laminating the porous resin film 11 and the liquid absorbent layer 12. The laminate 100 is a production material including all the components of the drip absorbent sheet 10 that is made into the drip absorbent sheet 10 by cutting into a product dimension.

As a film material for the porous resin film 11, a single-layered film or a multi-layered film of resins such as low-density polyethylene (LDPE), medium-density polyethylene (MDPE), high-density polyethylene (HDPE), linear low-density polyethylene (LLDPE), polypropylene (PP), polyethylene terephthalate (PET), ethylene-vinylacetate copolymer (EVA), and the like. Among these, a polyethylene film is preferred for its softness and cost-effectiveness.

In formation of the porous resin film 11, first, a surface active agent is blended into the abovementioned film material. Predetermined amounts of the film material and surface active agent are first measured and prepared, then placed into a mixer and stirred. The surface active agent is preferably contained in the porous resin film 11 in an amount of 1 to 3% by mass. An amount of the surface active agent of less than 1% by mass cannot suppress generation of static electricity, while an amount of the surface active agent of greater than 3% by mass increases hydrophilic properties of the surface of the porous resin film 11, leading to insufficient water repellency.

In the method of manufacturing of the present embodiment, by thus reducing the amount of the surface active agent being contained, manufacturing costs can be reduced. In addition, a step of blending the surface active agent into the resin film as a production material in advance is easier than a step of applying a surface active agent onto fiber of a nonwoven fabric and the like, because it is not necessary to specially provide additional mechanism or system for applying the surface active agent to the nonwoven fabric. Therefore, this step of blending can contribute to an improvement in productivity.

As the surface active agent, a non-ionic surface active agent such as polyoxyethylene alkyl amine, polyoxyethylene alkyl amide, polyoxyethylene alkyl ether, polyoxyethylene alkyl phenyl ether, glycerin fatty acid ester, sorbitan fatty acid ester and the like; an anionic surface active agent such as alkyl sulfonate, alkyl benzene sulfonate, alkyl sulfate, alkyl phosphate and the like; a cation surface active agent such as quaternary ammonium chloride, quaternary ammonium sulfate, and quaternary ammonium nitrate; or an amphoteric surface active agent such as an alkyl betaine type, alkyl imidazoline type, or alkyl alanine type surface active agent can be used.

The film material with the surface active agent thus blended thereinto is formed into a film by extrusion molding or the like. The thickness of the porous resin film 11 thus formed is 1 to 70 micrometer, preferably 30 to 70 micrometer.

During or after the extrusion molding, pores are formed in the porous resin film 11. The diameter of each of the pores is no greater than 5.0 mm, and more preferably approximately 0.1 to 2.0 mm. In this respect, pores that are too large are not preferable since the drip absorbed by the absorbent layer 12 will be visible through the pores. On the other hand, if the pores are too small, it will be difficult to absorb the drip by the absorbent layer 12 through the pores 11a.

As a component of the absorbent layer 12, nonwoven fabric such as air-laid nonwoven fabric and thermal bonded nonwoven fabric; paper; urethane; and fiber mainly composed of pulp such as air-laid pulp can be used. Among these, the fiber mainly composed of pulp is preferably used for its absorbent properties of drip released from meat and fish. As the pulp, wood pulp such as softwood pulp as well as non-wood pulp such as kenaf, abaca pulp and the like can be used. Alternatively, the liquid absorbent layer 12 can be composed of a plant origin high-absorbent polymer. The basis weight and the thickness of the fiber and the like composing the liquid absorbent layer 12 are set such that drip released from a foodstuff can be sufficiently absorbed. Regarding the air-laid pulp, the basis weight is preferably in a range of 10 to 120 g/m² under atomospheric pressure, at a temperature of 25 degrees Centigrade plus or minus 5 degrees Centigrade, and at a relative humidity of 65% plus or minus 20%, and the thickness is preferably in a range of approximately 0.3 to 3 mm, and more preferably in a range of approximately 0.5 to 2 mm, measured from one surface to the opposite surface thereof under a load of 3 g/cm².

In the laminating step, the laminate 100 is formed by laminating and bonding the abovementioned porous resin film 11 and the liquid absorbent layer 12. As a bonding method for the porous resin film 11 and the liquid absorbent layer 12, thermal bonding or thermal lamination can be exemplified. In addition, the porous resin film 11 and the liquid absorbent layer 12 can be bonded by a hot melt adhesive in bonding portions (not illustrated) that are scattered over a whole surface of the liquid absorbent layer 12. Alternatively, a material resin for the porous resin film 11 can be melt-extruded on the surface of the liquid absorbent layer 12, and then solidified into the porous resin film 11 having pores.

Cutting Step

Next, the cutting step is described with reference to FIG. 3. This step is for cutting the laminate 100 prepared in the laminating step into a product dimension, thereby obtaining a plurality of the drip absorbent sheets 10. As shown in FIG. 3, the cutting step includes: (a) a cutting preparation step for rolling out the laminate 100 prepared in the laminating step, being made into a roll, while applying an appropriate tension; (b) a first cutting step for making an incision along the longitudinal direction of the sheet by a first cutter 20; and (c) a second cutting step for cutting in a width direction of the sheet by a second cutter 25.

The laminate 100 thus cut into an appropriate dimension in the first cutting step (b) and the second cutting step (c) includes a plurality of the drip absorbent sheets 10. The cutting step is only required to be a cutting method that can obtain an appropriate product dimension, and is not limited to the method with the steps exemplarily described above.

Product Stacking Step

Next, the product stacking step (d) is described with reference to FIG. 3. This step is for stacking the drip absorbent sheets 10 obtained in the cutting step into stacks of drip absorbent sheets 10 and packing such stacks into a shipping state. The drip absorbent sheets 10 are finally shipped in the stacks obtained in this step. As a method for the product stacking step, any method that can appropriately stack the product can be used.

Charge Neutralization Process

Among the abovementioned steps, in at least one of the cutting step and the product stacking step, a contactless charge neutralization process is performed with respect to a front surface of the porous resin film 11 composing the laminate 100 or the drip absorbent sheet 10. As described above, the porous resin film 11 of the present embodiment contains a minute amount of the surface active agent; however, by this charge neutralization process, generation of static electricity on the laminate 100 or the drip absorbent sheet 10 can be further suppressed. Although FIG. 3 shows an example of employing an ion generator 30 in the product stacking step (d) and performing the charge neutralization process in the product stacking step (d), the charge neutralization process is not limited to be in the product stacking step. A method of manufacturing the drip absorbent sheet 10 in which the charge neutralization process may be performed with respect to the front surface of the porous resin film 11 in one or some or all of: the cutting preparation step (a); the first cutting step (b); the second cutting step (c); or the product stacking step (d), is also within the scope of embodiments of the present invention.

Generally, a charge neutralization process can be performed by spraying an antistatic spray or other charge neutralization method requiring contact. However, for hygiene reason, such charge neutralization methods are not preferable for the drip absorbent sheet that is to be laid under a foodstuff. The charge neutralization process in the manufacturing process of the drip absorbent sheet is preferably contactless. As such a charge neutralization process, a charge neutralization process by an ion generator (ionizer) can be exemplified.

The ionizer is an apparatus that removes static electricity by applying ionized air to a target, thereby alleviating an electrically-charged state of the target. The ionizer can be of corona discharge type; radioactive type; soft X-ray type; ultraviolet type; and the like. In the method of manufacturing according to the present embodiment, an ionizer of corona discharge type can be particularly preferably used, due to handling and operation thereof being relatively simple.

The ionizer of corona discharge type neutralizes static electricity by: applying high voltage from a high-voltage power supply to a discharge needle; generating corona discharge from a tip of the discharge needle; generating ions by electrolysis of air around the discharge needle; and applying ions to an electrically charged object. In the present embodiment, the voltage of the ionizer is 100 V, the distance from the tip of discharge needle to the object is 5 mm, and the discharge time is 0.15 seconds for an object with a thickness of 160 mm.

According to the method of manufacturing the drip absorbent sheet 10 of the present embodiment, adjustment of the amount of the surface active agent contained in the porous resin film 11 to a limited range; and a charge neutralization process being performed parallel to the manufacturing process, thus allow low-cost, high-speed, and stable manufacture of the drip absorbent sheet 10 that leaves less drip. More specifically, the method of manufacturing realizes stable cutting and lamination even in high-speed processing under adverse conditions, e.g., with dry atmosphere and high static electricity.

### EXAMPLES

Several Examples will be now described; however, embodiments of the present invention are not limited to these Examples.

### Examples 1 and 2, Comparative Examples 1 to 5

In all of Examples and Comparative Examples, a drip absorbent sheet was manufactured by the abovementioned laminating step, cutting step, and product stacking step. In all of Examples and Comparative Examples, the porous resin film was mainly composed of polyethylene of 25 g/m² in basis weight and the liquid absorbent layer was mainly composed of air-laid pulp of 52 g/m² in basis weight. Glycerin fatty acid ester was used as the surface active agent blended into the porous resin film. These layers were laminated by heat lamination to form a laminate; and then the laminate was cut into a 65 mm×120 mm piece by a cutter, thereby obtaining drip absorbent sheets. Thereafter, these drip absorbent sheets were stacked into stacks of 100 sheets in package cases. Examples and Comparative Examples were different in the amount of the surface active agent contained, as shown in Table 1. In addition, as shown in Table 1, a charge neutralization process by an ionizer was performed during the product stacking step (d) for Examples 1 and 2, and Comparative Examples 4 and 5. For Comparative Examples 1 to 3, the drip absorbent sheet was manufactured with the ionizer turned off, without performing the charge neutralization process.

Regarding Examples and Comparative Examples thus manufactured, results of assessment of water repellency of the front surface of the porous resin film of the drip absorbent sheet, and suppression of static electricity during the manufacturing process of the drip absorbent sheet are shown in Table 1. Evaluation was graded as: Very Good; Good; Moderate; and Poor.

TABLE 1

| | Example | Example | Comparative | Comparative | Comparative | Comparative | Comparative |
|---|---|---|---|---|---|---|---|
| | 1 | 1 | Example 1 | Example 2 | Example 3 | Example 4 | Example 5 |
| Surface | 1 | 3 | 5 | 1 | 3 | 5 | 0.5 |
| Active | | | | | | | |
| Agent (% by | | | | | | | |
| mass) | | | | | | | |
| Ionizer | Yes | Yes | No | No | No | Yes | Yes |
| Water | Very | Good | Poor | Very | Moderate | Poor | Good |
| Repellency | Good | | | Good | | | |
| of Surface | | | | | | | |
| Suppression | Good | Good | Good | Poor | Poor | Good | Moderate |
| of Static | | | | | | | |
| Electricity | | | | | | | |

From Examples and Comparative Examples, it can be observed that two problems: maintaining water repellency of the surface of the porous resin film; and suppressing generation of static electricity during manufacturing process, can be solved simultaneously where the amount of the surface active agent is limited to 1 to 3% by weight and the charge neutralization process is performed.

This application claims the benefit of Japanese Application No. 2010-223034 the entire disclosure of which is incorporated by reference herein.

1. A method of manufacturing a drip absorbent sheet, the drip absorbent sheet having
a porous resin film containing 1 to 3% by mass of a surface-active agent and having a plurality of pores through which drip from a foodstuff is passable; and
a liquid absorbent layer laminated with the porous resin film,
the method comprising:
a laminating step of laminating the porous resin film and the liquid absorbent layer;
a cutting step of cutting a laminate obtained in the laminating step into a plurality of drip absorbent sheets of a predetermined product dimension; and
a product stacking step of stacking the drip absorbent sheets after the cutting step into stacks,
wherein, in at least one of the cutting step and the product stacking step, a contactless charge neutralization process is performed with respect to a front surface of the porous resin film.

2. The method according to claim 1, wherein the contactless charge neutralization process is performed by an ion generator of corona discharge type.

3. The method according to claim 1, wherein the porous resin film is a polyethylene film.

4. The method according to claim 1,
wherein the liquid absorbent layer comprises fiber mainly composed of pulp.

5. The method according to claim 1, further comprising blending the surface-active agent into a material of the porous resin film.

6. The method according to claim 1,
wherein the contactless charge neutralization process is performed by an ion generator of a type selected from the group consisting of corona discharge type, radioactive type, soft X-ray type and ultraviolet type.

7. The method of manufacturing a drip absorbent sheet according to claim 1,
wherein a diameter of each of pores is no less than 0.1 mm and no greater than 2.0 mm.

8. The method of manufacturing a drip absorbent sheet according to claim 1,
the porous resin film and the liquid absorbent layer are bonded by thermal bonding or thermal lamination, or hot melt adhesive applied a portion of a surface of the liquid absorbent layer in the laminating step.

9. The method of manufacturing a drip absorbent sheet according to claim 1,
wherein a material resin for the porous resin film is melt-extruded on a surface of the liquid absorbent layer, and then pores are formed in the porous resin film in the laminating step.

10. A method of manufacturing a drip absorbent sheet, the drip absorbent sheet having
a porous resin film containing 1 to 3% by mass of a surface-active agent and having a plurality of pores through which drip from a foodstuff is passable; and
a liquid absorbent layer laminated with the porous resin film,
the method comprising:
a cutting step of cutting a laminate of the porous resin film and the liquid absorbent layer into a plurality of drip absorbent sheets of a predetermined product dimension; and
a product stacking step of stacking the drip absorbent sheets after the cutting step into stacks,
wherein, in at least one of the cutting step and the product stacking step, a contactless charge neutralization process is performed with respect to a front surface of the porous resin film.
